(19) United States
(12) Patent Application Publication
(10) Pub. No.: US 2025/0001401 A1
(43) Pub. Date: Jan. 2, 2025

(54) SORBENT MATERIAL WITH HIGH NITROGEN CONTENT

(71) Applicant: CALGON CARBON CORPORATION, Moon Township, PA (US)

(72) Inventor: Jason Paul MAZZOCCOLI, Pittsburgh, PA (US)

(73) Assignee: CALGON CARBON CORPORATION, Moon Township, PA (US)

(21) Appl. No.: 18/756,484

(22) Filed: Jun. 27, 2024

Related U.S. Application Data
(60) Provisional application No. 63/524,109, filed on Jun. 29, 2023.

(51) Int. Cl. B01J 20/32; B01J 20/20; B01J 20/28; B01J 20/30

(52) U.S. Cl. CPC B01J 20/3204; B01J 20/20; B01J 20/28011; B01J 20/28066; B01J 20/3078; B01J 20/3085; B01J 20/3234

(57) ABSTRACT

A sorbent material may include activated carbon, wherein the activated carbon has been subjected to an impregnation with a nitrogen-containing compound, a calcination, an oxidation, or combinations thereof, wherein the sorbent material includes about 5 wt. % to about 10 wt. % nitrogen and has an iodine number of about 1000 mg/g to about 1500 mg/g. Methods of producing such a sorbent material are also described.

### CROSS-REFERENCE TO RELATED APPLICATIONS

This application claims priority to U.S. Provisional Application No. 63/524,109, which was filed on Jun. 29, 2023, and is hereby incorporated by reference herein in its entirety.

### BACKGROUND

Sorbent materials have widespread use in many fields, such as the removal of harmful contaminants from water sources and gas streams. Sorbents which have been chemically modified are well known for their oxidative and decomposition properties, may have enhanced catalytical properties, and offer improved performance over untreated sorbents. In particular, sorbents which have high surface areas and have been treated to contain a high level of nitrogen may be employed in numerous applications. Typically, these sorbent materials are formed from activated carbon and carbonaceous chars which are thermally treated with a nitrogen-containing precursor, followed by activation, to produce the catalytic activated carbon. Alternately, a nitrogen-containing precursor can be charred and activated. Activation is normally carried out at high temperature with an activating method such as steam (water), carbon dioxide, or oxygen. These methods are described in several U.S. patents, including U.S. Pat. Nos. 6,342,129, 6,706,194, 5,536,849, 5,338,458, and 9,174,2105, all of which are incorporated by reference in their entirety.

The activation process gasifies the surface portion of the carbonaceous char or other sorbent material, which results in small pores being formed as the carbon or other material on the surface of the sorbent particles vaporizes. These pores are responsible for the high total surface area of the sorbent material, and therefore its high performance. However, this gasification during the activation process is not selective to the materials being removed from the surface through vaporization because the oxygen in its various forms (air, pure O₂, dissociated oxygen from steam, dissociated oxygen from CO₂, etc.) at high temperatures is a powerful carbon gasifying and oxidizing agent. As a result, much of the incorporated nitrogen which is responsible for the catalytic activity and which is part of the surface composition of the sorbent material is disadvantageously removed during activation. This is counterproductive and reduces the catalytic properties of the sorbent materials, and therefore deteriorates its performance in the removal and/or destruction of deleterious compounds from water and gas streams.

Iodine number is another measure of a sorbent material's activity and is defined by the amount of iodine absorbed by the sorbent material, with a higher iodine number corresponding to a higher adsorption capacity and performance. Historically, methods drawn to increasing the iodine number of a sorbent material do so at the expense of any surface treatment on the sorbent material, such as impregnated nitrogen, meaning that a simultaneously high nitrogen content and high iodine are not possible with traditional treatment and activation methods. There remains a need for methods to maximize both of these properties to provide high performing sorbent materials with desired surface characteristics. The present disclosure addresses this problem and provides a method of producing a carbon with a high iodine number and high nitrogen content.

### SUMMARY

In some aspects, the techniques described herein relate to a sorbent material, including: activated carbon, wherein the activated carbon has been subjected to an impregnation with a nitrogen-containing compound, and one of a calcination, optional oxidation, or both a calcination and an oxidation, and wherein the sorbent material includes about 5 wt. % to about 10 wt. % nitrogen and has an iodine number of about 1000 mg/g to about 1500 mg/g.

In some aspects, the techniques described herein relate to a sorbent material, wherein the activated carbon includes a carbonaceous material which is formed from bituminous coal, sub-bituminous coal, lignite coal, anthracite coal, wood, wood chips, sawdust, peat, nut shells, pits, coconut shell, babassu nut, macadamia nut, dende nut, peach pit, cherry pit, olive pit, walnut shell, wood, lignin, polymers, nitrogen-containing polymers, resins, petroleum pitches, bagasse, rice hulls, corn husks, wheat hulls and chaff, graphenes, carbon nanotubes, and polymer fibers.

In some aspects, the techniques described herein relate to a sorbent material, wherein the carbonaceous material includes coconut shell.

In some aspects, the techniques described herein relate to a sorbent material, wherein the impregnation includes contacting the activated carbon with an aqueous solution of about 10 wt. % to about 50 wt. % of the nitrogen-containing compound at a temperature of about 25° C. to about 75° C., combining the activated carbon and the nitrogen-containing compound in a dry admixture, or combinations thereof.

In some aspects, the techniques described herein relate to a sorbent material, wherein the nitrogen-containing compound includes ammonia, ammonium salts, ammonium carbonate and bicarbonate, ammonium thiocyanate, azodicarbonamide, diammonium phosphate, dicyandiamide, guanidine hydrochloride, guanidine thiocyanate, guanine, melamine, thiourea, urea, and combinations thereof.

In some aspects, the techniques described herein relate to a sorbent material, wherein the calcination is performed at a temperature of about 350° C. to about 1000° C.

In some aspects, the techniques described herein relate to a sorbent material, wherein the optional oxidation is performed at a temperature of about 300° C. to about 500° C.

In some aspects, the techniques described herein relate to a sorbent material, wherein the sorbent material includes about 6 wt. % to about 8 wt. % nitrogen.

In some aspects, the techniques described herein relate to a sorbent material, wherein the sorbent material has an iodine number of about 1100 mg/g to about 1400 mg/g.

In some aspects, the techniques described herein relate to a sorbent material, wherein the sorbent material includes about 6 wt. % to about 8 wt. % nitrogen and has an iodine number of about 1100 mg/g to about 1400 mg/g.

In some aspects, the techniques described herein relate to a sorbent material, wherein the sorbent material includes less than about 2% ash.

In some aspects, the techniques described herein relate to a method for making a sorbent material which includes about 5 wt. % to about 10 wt. % nitrogen and has an iodine number of about 1000 mg/g to about 1500 mg/g, the method including: a. providing an activated carbon, b. performing an initial treatment on the activated carbon, the initial treatment including: i. impregnation with a nitrogen-containing compound, and ii. one of calcination, oxidation, or both calcination and oxidation (in any order), to yield an initial activated carbon, c. performing an optional intermediate treatment on the initial activated carbon which is performed 0-3 times, wherein each intermediate treatment independently includes: i. impregnation with the nitrogen-containing compound, and ii. one of calcination, oxidation, or both calcination and oxidation (in any order), to yield an intermediate activated carbon, d. performing a final treatment on the initial activated carbon or the intermediate activated carbon, the final treatment including: i. impregnation with the nitrogen-containing compound, and ii. one of calcination, oxidation, or both calcination and oxidation (in any order), to yield the sorbent material.

In some aspects, the techniques described herein relate to a method, wherein the activated carbon includes carbonaceous material which is formed from one or more of bituminous coal, sub-bituminous coal, lignite coal, anthracite coal, wood, wood chips, sawdust, peat, nut shells, pits, coconut shell, babassu nut, macadamia nut, dende nut, peach pit, cherry pit, olive pit, walnut shell, wood, lignin, polymers, nitrogen-containing polymers, resins, petroleum pitches, bagasse, rice hulls, corn husks, wheat hulls and chaff, graphenes, carbon nanotubes, or polymer fibers.

In some aspects, the techniques described herein relate to a method, wherein the carbonaceous material is coconut shell.

In some aspects, the techniques described herein relate to a method, wherein impregnation of the initial treatment, optional intermediate treatment, and final treatment includes contacting the activated carbon with an aqueous solution of about 10 wt. % to about 50 wt. % of the nitrogen-containing compound at a temperature of about 25° C. to about 75° C., combining the activated carbon and the nitrogen-containing compound in a dry admixture in a ratio of about 1:1 to about 5:1, or combinations thereof.

In some aspects, the techniques described herein relate to a method, wherein the nitrogen-containing compound includes ammonia, ammonium salts, ammonium carbonate and bicarbonate, ammonium thiocyanate, azodicarbonamide, diammonium phosphate, dicyandiamide, guanidine hydrochloride, guanidine thiocyanate, guanine, melamine, thiourea, urea, and combinations thereof.

In some aspects, the techniques described herein relate to a method, wherein the calcination of the initial treatment, optional intermediate treatment, and final treatment is performed at about 350° C. to about 1000° C.

In some aspects, the techniques described herein relate to a method, wherein the calcination of the initial treatment, optional intermediate treatment, and final treatment is performed at a temperature of about 350° C. to about 600° C.

In some aspects, the techniques described herein relate to a method, wherein the calcination of the initial treatment, optional intermediate treatment, and final treatment is performed at a temperature of about 600° C. to about 1000° C.

In some aspects, the techniques described herein relate to a method, wherein the oxidation of the initial treatment, optional intermediate treatment, and final treatment is performed at about 300° C. to about 500° C.

In some aspects, the techniques described herein relate to a method, wherein step c. ii. is selected identically with step b. ii.

In some aspects, the techniques described herein relate to a method, wherein c. ii. is selected differently from step b. ii.

In some aspects, the techniques described herein relate to a method, wherein step d. ii. is selected identically with step b. ii.

In some aspects, the techniques described herein relate to a method, wherein step d. ii. is selected differently from step b. ii.

In some aspects, the techniques described herein relate to a method, wherein steps c. ii. and d. ii. are both selected identically with step b. ii.

In some aspects, the techniques described herein relate to a method, wherein steps c. ii. and d. ii are both selected differently from step b. ii.

### BRIEF DESCRIPTION OF DRAWINGS

Aspects, features, benefits, and advantages of the embodiments described herein will be apparent with regard to the following description, appended claims, and accompanying drawings where:

FIG. 1 is a graph of bulk nitrogen content vs. calcination temperature in a sorbent material, comparing single and double impregnations with a nitrogen-containing compound.

FIG. 2 is a bar graph of bulk nitrogen content vs. calcination temperature in a sorbent material, comparing single and double impregnations with a nitrogen-containing compound.

### DETAILED DESCRIPTION

This disclosure is not limited to the particular systems, devices and methods described, as these may vary. The terminology used in the description is for the purpose of describing the particular versions or embodiments only and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

As used herein, the term “about” means plus or minus 10% of the numerical value of the number with which it is being used. For example, “about 50%” means in the range of 45-55%.

As used herein, the term “sorbent material” means any material that exhibits adsorbent properties, absorbent properties, or a combination of adsorbent properties and absorbent properties. Adsorbent properties mean that atoms, ions, or molecules adhere to the surface of the material. Absorbent properties means that atoms, ions, or molecule enter and are retained by a bulk phase of the material. By way of example, sorbent materials include but are not limited to activated carbon, reactivated carbon, natural and synthetic zeolite, silica, silica gel, alumina, zirconia, and diatomaceous earths. As used herein, “sorbent material” is a material whose constituent components are substantially adsorbent and/or absorbent, with only minimal components that are not adsorbent and/or absorbent (for example, the minimal amount of binder that is required for activated carbon pellets to maintain their shape).

As used herein, the term “sorbent” means any composition or composite that includes a sorbent material in a blend, mixture, composite, or compound with one or more additional materials that do not exhibit adsorbent properties. By way of example, one embodiment of sorbent includes an activated carbon sorbent material mixed with a thermally conductive filler.

As used herein, the term “carbonaceous material” means a material that contains carbon that has not been thermally activated or chemically activated. Carbonaceous material may have been mechanically treated, thermally treated, or chemically treated, and can even have weakly sorbent properties, but carbonaceous material does not adsorb compounds in substantial amounts as would be expected of a material such as activated carbon. Examples of carbonaceous material include but are not limited to bituminous coal, sub-bituminous coal, lignite coal, anthracite coal, wood, wood chips, sawdust, peat, nut shells, pits, coconut shell, babassu nut, macadamia nut, dende nut, peach pit, cherry pit, olive pit, walnut shell, wood, lignin, polymers, nitrogen-containing polymers, resins, petroleum pitches, bagasse, rice hulls, corn husks, wheat hulls and chaff, graphenes, carbon nanotubes, or polymer fibers.

As used herein, the term “macropores” means pores within a sorbent that are greater than about 50 nm in diameter.

As used herein, the term “mesopores” means pores within a sorbent that have a diameter of about 2 nm to about 50 nm.

As used herein, the term “micropores” means pores within a sorbent that have a diameter of less than about 2 nm.

As used herein, the term “iodine number” means the property of a sorbent or sorbent material that is formed from carbonaceous material as determined by the industry standard test ASTM D4607-14 and refers specifically to gravimetric iodine number. Iodine number is reported in units of mass of iodine adsorbed per mass of sorbent or sorbent material. The iodine number is a measure of the equilibrium mass of iodine adsorbed on the surface of a normalized amount of sorbent or sorbent material. The iodine number is a measure of the surface area and porosity of a sorbent or sorbent material.

The “volumetric iodine number” may also be measured, and refers to the product of the iodine number (i.e., gravimetric iodine number) and the apparent density of the sorbent or sorbent material. The apparent density of the sorbent or sorbent material is obtained by the industry standard test ASTM D2854-09 (2019). The volumetric iodine number is reported in units of mass of iodine adsorbed per volume of sorbent or sorbent material.

In some embodiments, the present disclosure describes a sorbent material which has a high nitrogen content while simultaneously achieving a high iodine number. In some embodiments, the sorbent material includes a carbonaceous material which has been activated to form a precursor activated carbon, and the carbonaceous material includes one or more of bituminous coal, sub-bituminous coal, lignite coal, anthracite coal, wood, wood chips, sawdust, peat, nut shells, pits, coconut shell, babassu nut, macadamia nut, dende nut, peach pit, cherry pit, olive pit, walnut shell, wood, lignin, polymers, nitrogen-containing polymers, resins, petroleum pitches, bagasse, rice hulls, corn husks, wheat hulls and chaff, graphenes, carbon nanotubes, and polymer fibers.

The sorbent material of the present disclosure has a nitrogen content of about 5 wt. % to about 10 wt. % and an iodine number of about 1000 mg/g to about 1500 mg/g. For example, in some embodiments, the sorbent material has a nitrogen content of about 6 wt. % to about 8 wt. % and an iodine number of about 1100 mg/g to about 1400 mg/g, or a nitrogen content of about 5 wt. % to about 7 wt. % and an iodine number of about 1200 mg/to about 1400 mg/g. In some embodiments, the sorbent material has a nitrogen content of about 5 wt. % to about 7 wt. % and an iodine number of about 1100 mg/g to about 1400 mg/g. In some embodiments, the sorbent material has a nitrogen content of about 6 wt. % to about 8 wt. % and an iodine number of about 1200 mg/to about 1400 mg/g.

In some embodiments, the sorbent material has a nitrogen content of about 5 wt. % to about 10 wt. %, for example, the nitrogen content is about 5 wt. %, about 5.5 wt. %, about 6 wt. %, about 6.5 wt. %, about 7 wt. %, about 7.5 wt. %, about 8 wt. %, about 8.5 wt. %, about 9 wt. %, about 9.5 wt. %, about 10 wt. %, or any range or value contained within the above values.

In some embodiments, the sorbent material of the present disclosure has an iodine number of about 1000 mg/g to about 1500 mg/g, such as about 1000 mg/g, about 1050 mg/g, about 1100 mg/g, about 1150 mg/g, about 1200 mg/g, about 1250 mg/g, about 1300 mg/g, about 1350 mg/g, about 1400 mg/g, about 1450 mg/g, about 1500 mg/g, or any range or value contained within the above values.

In some embodiments, the sorbent material of the present disclosure includes less than about 2% ash, for example less than about 2%, less than about 1.5%, less than about 1%, less than about 0.5%, and so forth.

In some embodiments, the sorbent material of the present disclosure has been subjected to an impregnation with a nitrogen-containing compound, and one of a calcination, an oxidation, or a calcination and an oxidation. In some embodiments, the sorbent material of the present disclosure has been subjected to multiple instances of the above processes.

Traditionally, sorbent materials with high nitrogen content exhibit low iodine numbers, and vice versa. That is, nitrogen content and iodine number are typically inversely proportional to one another. Sorbent materials with high iodine numbers (above about 1000 mg/g) are typically prepared via high temperature calcination processes, which drive off nitrogen. Increasing the iodine number of a sorbent material is typically at the expense of nitrogen content (or other additives impregnated onto the surface of the sorbent material) because the calcination steps that historically lead to higher iodine numbers are non-selective and degrade the nitrogen that has been impregnated, lowering the nitrogen content. Additionally, currently practiced methods of producing sorbent materials with high nitrogen content (above about 5 wt. %) are difficult to implement at scale and involve significant safety and environmental risks. For example, although contacting a sorbent material or sorbent material precursor with gaseous ammonia can result in high nitrogen content, gaseous ammonia can be harmful to humans and can result in flammable decomposition products at high temperatures, such as those typically employed for sorbent material preparation. Ammonia emissions further contribute to pollution and can result in significant soil and plant damage. It is thus desirable to employ methods than are safer and less toxic while still achieving the desired sorbent material properties.

In some embodiments, the present disclosure describes safe, scalable, and environmentally friendly methods of making sorbent materials such that they have desired properties as described above. According to some embodiments of the present disclosure, a method of preparing a sorbent material which has a nitrogen content of about 5 wt. % to about 10 wt. % and has an iodine number of about 1000 mg/g to about 1500 mg/g includes steps of providing an activated carbon and performing an initial treatment on the activated carbon, wherein the initial treatment includes impregnation with a nitrogen-containing compound, and one of calcination, oxidation, or both calcination and oxidation (in any order) to yield an initial activated carbon. After obtaining the initial activated carbon, the method includes performing an optional intermediate treatment which is performed 0-3 times. Each optional intermediate treatment independently includes impregnation with a nitrogen-containing compound, and one of calcination, oxidation, or both calcination and oxidation (in any order) to yield an intermediate activated carbon. The method also includes performing a final treatment on the initial activated carbon or the intermediate activated carbon, wherein the final treatment includes impregnation with a nitrogen-containing compound, and one of calcination, oxidation, or both calcination and oxidation (in any order) to yield the sorbent material.

There are provided one or more carbonaceous materials that are precursors to final sorbents. In some embodiments, these carbonaceous materials have been mechanically, thermally, or chemically treated prior to activation to produce activated carbon. Examples of carbonaceous material include but are not limited to bituminous coal, sub-bituminous coal, lignite coal, anthracite coal, wood, wood chips, sawdust, peat, nut shells, pits, coconut shell, babassu nut, macadamia nut, dende nut, peach pit, cherry pit, olive pit, walnut shell, wood, lignin, polymers, nitrogen-containing polymers, resins, petroleum pitches, bagasse, rice hulls, corn husks, wheat hulls and chaff, graphenes, carbon nanotubes, and polymer fibers.

In some embodiments, the carbonaceous material is coconut shell. Coconut shell carbonaceous materials are particularly useful because when coconut shell is activated to form activated carbon, it exhibits excellent adsorption of chloroform and other organic compounds relative to activated carbons formed from other starting materials.

After the carbonaceous material is provided, it is activated. The activation process is not limited, and any suitable activation process may be used. Activation processes depend on the type of carbonaceous material utilized and the desired form the final activated carbon. Activation steps may include one or more of pyrolysis of the carbonaceous material to form a charcoal, pulverizing the charcoal, mixing a binder with the pulverized charcoal, briquetting the pulverized charcoal and binder, crushing the briquettes, sizing the crushed briquettes, and baking the sized briquettes or the briquettes themselves to carbonize, cure, or remove the binder. However, in all instances, the carbonaceous material in any form is thermally activated, chemically activated, or thermally and chemically activated. Thermal activation is performed by heating the baked briquettes or sized particles in the presence of one or more of water, oxygen, and carbon dioxide. Chemical activation is performed by impregnating the baked briquettes or sized particles in the presence of a strong acid, strong base, or a salt. It should be noted that whether each of the above steps are included in the processing sometimes depends on the provided carbonaceous material. For example, when the carbonaceous material is coconut, process steps do not include “reagglomeration,” which is the steps of mixing a binder with the pulverized charcoal, briquetting the pulverized charcoal and binder, crushing the briquettes, and sizing the crushed briquettes.

This disclosure describes methods of treating activated carbon. These treatment methods are performed after carbonaceous material has been activated to form activated carbon. As will be understood by those skilled in the art, activated carbon may be formed from numerous carbonaceous materials, including but not limited to bituminous coal, sub-bituminous coal, lignite coal, anthracite coal, wood, wood chips, sawdust, peat, nut shells, pits, coconut shell, babassu nut, macadamia nut, dende nut, peach pit, cherry pit, olive pit, walnut shell, wood, lignin, polymers, nitrogen-containing polymers, resins, petroleum pitches, bagasse, rice hulls, corn husks, wheat hulls and chaff, graphenes, carbon nanotubes, and polymer fibers, and each of these materials may impart different properties on the resulting sorbent material. As such, it may be advantageous to select an activated carbon formed from a particular carbonaceous material depending on the purpose for which the activated carbon will be used.

In some embodiments, treating the activated carbon includes impregnating the activated carbon with a nitrogen-containing compound. The nitrogen-containing compound may include ammonia, ammonium salts, ammonium carbonate and bicarbonate, ammonium thiocyanate, azodicarbonamide, diammonium phosphate, dicyandiamide, guanidine hydrochloride, guanidine thiocyanate, guanine, melamine, thiourea, urea, and combinations thereof. Impregnating the activated carbon with a nitrogen-containing compound may be carried out by any method known in the art. For example, impregnating the activated carbon with a nitrogen-containing compound can be achieved by combining the activated carbon with the nitrogen-containing compound in a dry admix, contacting the activated carbon with a solution of the nitrogen-containing compound, or contacting the activated carbon with the nitrogen-containing compound in a gaseous form.

In some embodiments, the impregnation includes contacting the activated carbon with an aqueous solution of about 10 wt. % to about 50 wt. % of the nitrogen-containing compound at a temperature of about 25° C. to about 75° C., combining the activated carbon and the nitrogen-containing compound in a dry admixture, or combinations thereof. In some embodiments, impregnation of the initial treatment, optional intermediate treatment, and final treatment includes contacting the activated carbon with an aqueous solution of about 10 wt. % to about 50 wt. % of the nitrogen-containing compound at a temperature of about 25° C. to about 75° C., combining the activated carbon and the nitrogen-containing compound in a dry admixture in a ratio of about 1:1 to about 5:1, or combinations thereof.

In some embodiments, impregnating the activated carbon with a nitrogen-containing compound includes contacting the activated carbon with an aqueous solution of the nitrogen-containing compound. In some embodiments, the aqueous solution of the nitrogen-containing compound includes about 10 wt. % to about 50 wt. % nitrogen-containing compound, for example about 10 wt. %, about 15 wt. %, about 20 wt. %, about 25 wt. %, about 30 wt. %, about 35 wt. %, about 40 wt. %, about 45 wt. %, about 50 wt. %, or any range or value contained within the above values. In some embodiments, contacting the activated carbon with the aqueous solution of the nitrogen-containing compound is conducted at a temperature of about 25° C. to about 75° C., for example about 25° C., about 30° C., about 35° C., about 40° C., about 45° C., about 50° C., about 55° C., about 60° C., about 65° C., about 70° C., about 75° C., or any range or value contained within the above values. In some embodiments, the aqueous solution of the nitrogen-containing compound is heated to a temperature of about 25° C. to about 75° C. prior to contacting with the activated carbon, or the aqueous solution is heated during contacting.

In some embodiments, impregnating the activated carbon with a nitrogen-containing compound includes mixing the activated carbon with the nitrogen-containing compound in a dry admix. In some embodiments, the ratio of activated carbon to the nitrogen-containing compound is about 1:1 to about 5:1, for example, about 1:1, about 1.5:1, about 2:1, about 2.5:1, about 3:1, about 3.5:1, about 4:1, about 4.5:1, about 5:1, or any range or value contained within the aforementioned values.

In some embodiments, the activated carbon is subjected to a calcination, subsequent to any activation process that formed the activated carbon from carbonaceous material. The calcination may be performed at a temperature of about 350° C. to about 1000° C., such as about 350° C., about 400° C., about 450° C., about 500° C., about 550° C., about 600° C., about 650° C., about 700° C., about 750° C., about 800° C., about 850° C., about 900° C., about 950° C., about 1000° C., or any range or value contained within the aforementioned values. The calcination may occur after or concurrent with impregnating the activated carbon with a nitrogen-containing compound.

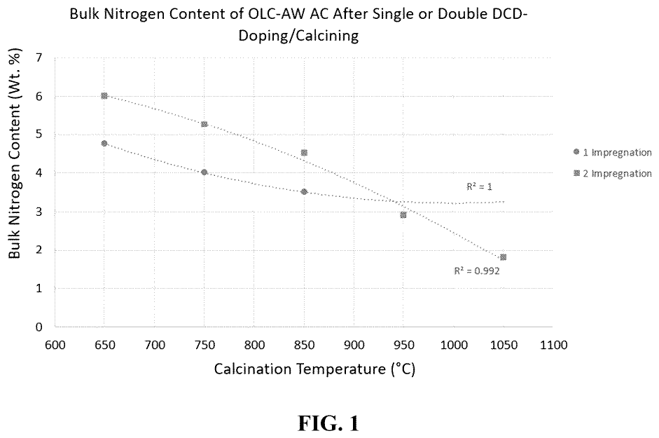

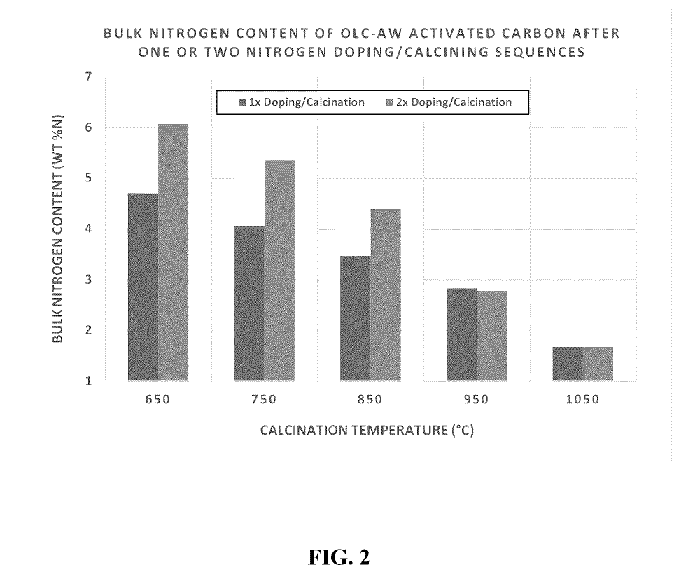

In some embodiments, the step of impregnating the activated carbon with a nitrogen-containing compound is repeated multiple times, for example, in an initial treatment, an intermediate treatment, and/or a final treatment. FIG. 1 compares the nitrogen content of sorbent materials according to some embodiments of the present disclosure, comparing sorbent materials that have been impregnated with a nitrogen-containing compound once with sorbent materials that have been impregnated twice. FIG. 1 is a graph of bulk nitrogen content vs. calcination temperature in a sorbent material, comparing single and double impregnations with a nitrogen-containing compound. Nitrogen content decreases with increasing calcination temperature as shown in FIG. 1, and nitrogen content increases when the activated carbon is impregnated with a nitrogen-containing compound twice. For doubly processed activated carbons, the bulk nitrogen content varied from about 6% after calcination at about 650° C. and decreased to 1.7% after calcination at about 1050° C. Increases in bulk nitrogen after two rounds impregnation and calcination are observed at temperature from about 650° C. to about 850° C., resulting in an increase in bulk nitrogen content compared to a singly impregnated and calcined counterpart. Without wishing to be bound by theory, above about 950° C., there is less benefit to pursuing two rounds of impregnation and calcination. It is presumed that calcination at temperatures at or above about 950° C. may be hot enough to remove additional nitrogen added during a second impregnation. FIG. 2 is a bar graph bulk nitrogen content vs. calcination temperature in a sorbent material, comparing single and double impregnations with a nitrogen-containing compound and further demonstrates this trend. As shown in FIG. 2, when calcining at 1050° C., the same nitrogen content was obtained for single and double impregnations.

In some embodiments, the activated carbon is oxidized. Oxidizing the activated carbon may be carried out by various techniques and may occur before, during, or after other treatment steps. In some embodiments, oxidizing the activated carbon can include contacting the activated carbon with an oxidizing agent. In some embodiments, the oxidizing agent includes at least one of nitric acid, potassium peroxymonosulfate, potassium persulfate, ammonium persulfate, sodium persulfate, hydrogen peroxide, peracetic acid, acetic acid, calcium hypochlorite, sodium hypochlorite, hypochlorous acid, benzoyl peroxide, sodium percarbonate, sodium perborate, organic peroxides, organic hydroperoxides, bleaching compounds, peroxide-based bleach, chlorine-based bleach, a mixture of hydrogen peroxide and urea, a mixture of peracetic acid and urea, and combinations of one or more of the above.

In some embodiments, oxidizing the activated carbon including a step of heating or otherwise treating the activated carbon and chemical oxidant or oxidizing agent. In such embodiments, heating includes heating the activated carbon and the oxidizing agent to a temperature of about 25° C., about 50° C., about 75° C., about 100° C., about 125° C., about 150° C., about 175° C., about 200° C., about 225° C., about 250° C., about 275° C., about 300° C., about 325° C., about 350° C., about 375° C., about 400° C., about 425° C., about 450° C., or any range or value contained within the above values. In some embodiments, the step of heating is performed in any range where the above temperature values are the lower bound of a range, i.e., heating may be performed at a temperature of at least about 25° C., at least about 50° C., at least about 75° C., at least about 100° C., at least about 125° C., at least about 150° C., at least about 175° C., at least about 200° C., at least about 225° C., at least about 250° C., at least about 275° C., at least about 300° C., at least about 325° C., at least about 350° C., at least about 375° C., at least about 400° C., at least about 425° C., at least about 450° C., or any combination of one or more of the preceding ranges. In some embodiments, the step of oxidizing is non-thermal process and is performed without the addition of any external heating to the mixture of the activated and the oxidizing agent.

In some embodiments, multiple oxidizing steps are performed on the activated carbon. The number of oxidizing steps is not particularly limited, and may be at least one oxidizing step, at least two oxidizing steps, at least three oxidizing steps, or at least four oxidizing steps. The steps may be denoted first oxidizing step, second oxidizing step, third oxidizing step, fourth oxidizing step, and so forth. Contacting the activated carbon with the oxidizing agent is, in some embodiments, combined with oxidizing the activated carbon under specified atmospheric conditions.

The additional step or steps of oxidizing the activated under a specified atmosphere includes one or more of a specified atmospheric temperature, a specified atmospheric composition, or a specified atmospheric pressure. In some embodiments, the combined step of an additional oxidizing process is carried out by exposing the activated carbon to an oxygen containing environment and heating the activated carbon to a temperature of about 150° C. to about 1050° C. In some embodiments, the temperature of oxidizing is about 150° C. to about 250° C., about 250° C. to about 350° C., about 350° C. to about 450° C., about 450° C. to about 550° C., about 550° C. to about 650° C., about 650° C. to about 750° C., about 750° C. to about 850° C., about 850° C. to about 950° C., about 950° C. to about 1050° C., or any of those disclosed endpoints, or any range that is made of a combination of any of the above ranges or values within those ranges.

In other embodiments, an oxidizing step is performed in an oxygen containing environment that contains atmospheric air, oxygen, steam, ozone, oxygen plasma, nitrogen oxide, and hydrogen peroxide, carbon dioxide, inert gas, noble gas, or any combination of one or more the above. The activated carbon is contacted with or placed within the above oxygen containing environment. The amount of oxygen is not limited. In some embodiments, the amount of oxygen is about 5 vol. %, about 10 vol. %, about 15 vol. %, about 20 vol. %, about 20.95 vol. % (i.e., air), about 25 vol. %, about 30 vol. %, about 35 vol. %, about 40 vol. %, about 45 vol. %, about 50 vol. %, about 55 vol. %, about 60 vol. %, about 65 vol. %, about 70 vol. %, about 75 vol. %, about 80 vol. %, about 85 vol. %, about 90 vol. %, about 95 vol. %, or about 100 vol. % (i.e., pure oxygen). The amount of oxygen can be any combination of one or more of the above values to form a range. In some embodiments, the range is about 0 vol. % to about 20 vol. %, about 0 vol. % to about 20.95 vol. %, about 20 vol. % to about 40 vol. %, about 40 vol. % to about 60 vol. %, about 60 vol. % to about 80 vol. %, or about 80 vol. % to about 100 vol. %.

In some embodiments, the oxygen containing environment is dry, and includes no moisture or substantially no measurable moisture. In other embodiments, the oxidation environment of any of the above compounds can also be humidified. The level of humidification can be about 10-20%, about 20-40%, about 40-60%, about 60-80%, about 80-100%, about 100% or saturated, or values and ranges derived from any combination of the above endpoints or ranges. Each of the above values is measured as relative humidity, which means the present state of absolute humidity relative to a maximum humidity for a given temperature.

In some embodiments, oxidation is accomplished by a non-thermal process. In such embodiments, the activated carbon is oxidized by contacting the activated carbon with hydrogen peroxide, ozone, chlorine, persulfates, percarbonates, oxidizing acids such as nitric acid, or any combination thereof in the liquid or vapor phase at temperatures less than about 100° C. It should be noted that some sorbents including carbons slowly oxidize in the presence of air with or without moisture at room temperature and this oxidation, although slow, would eventually be sufficient to produce an oxidized sorbent precursor. In some embodiments, the oxidizing step is omitted, i.e., the activated carbon is not oxidized by any step faster than the above-described slow oxidation that takes place naturally at room temperature under normal conditions.

In some embodiments, there is provided a method for making a sorbent material which comprises about 5 wt. % to about 10 wt. % nitrogen and has an iodine number of about 1000 mg/g to about 1500 mg/g, the method including steps of a. providing an activated carbon, b. performing an initial treatment on the activated carbon, the initial treatment including: i. impregnation with a nitrogen-containing compound, and ii. one of calcination, oxidation, or both calcination and oxidation (in any order) to yield an initial activated carbon, c. performing an optional intermediate treatment on the initial activated carbon which is performed 0-3 times, wherein each intermediate treatment independently includes: i. impregnation with the nitrogen-containing compound, and ii. one of calcination, oxidation, or both calcination and oxidation (in any order) to yield an intermediate activated carbon, d. performing a final treatment on the initial activated carbon or the intermediate activated carbon, the final treatment including: i. impregnation with the nitrogen-containing compound, and ii. one of calcination, oxidation, or both calcination and oxidation (in any order) to yield the sorbent material.

In some embodiments, the method of making the sorbent material as described herein includes performing an initial treatment on the activated carbon. The initial treatment includes impregnation with a nitrogen-containing compound, and one of calcination, oxidation, or both calcination and oxidation, performed in any order. For example, in some embodiments, the initial treatment includes impregnation with a nitrogen-containing compound and calcination. In some embodiments, the initial treatment includes impregnation with a nitrogen-containing compound and oxidation. In some embodiments, the initial treatment includes impregnation with a nitrogen-containing compound, calcination, and oxidation, wherein the calcination and oxidation are performed in any order. The initial treatment yields an initial activated carbon.

In some embodiments, the method of making the sorbent material as described herein includes performing an optional intermediate treatment on the initial activated carbon, wherein the optional intermediate treatment is performed 0-3 times. As such, in some embodiments, the optional intermediate treatment is omitted. In some embodiments, the optional intermediate treatment is performed one time, two times, or three times. The optional intermediate treatment includes impregnation and one of calcination, oxidation, or both calcination and oxidation, performed in any order. In embodiments where the optional intermediate treatment is performed multiple times, i.e., two times or three times, each intermediate treatment step independently includes impregnation and one of calcination, oxidation, or both calcination and oxidation, performed in any order. For example, in some embodiments, the optional intermediate treatment is performed two times, and includes a first intermediate treatment which includes impregnation and calcination, and a second intermediate treatment which includes impregnation and both calcination and oxidation. In some embodiments, the optional intermediate treatment is performed two times, and includes a first intermediate treatment which includes impregnation and oxidation, and a second intermediate treatment which includes impregnation and calcination. Other combinations of two or more intermediate steps, each including impregnation and one of calcination, oxidation, or both calcination and oxidation are possible. Each intermediate step may be independently selected from other intermediate steps, and may be the same as or different from other steps in the method disclosed herein. The optional intermediate treatment yields an intermediate activated carbon.

In some embodiments, the method of making the sorbent material as described herein includes performing a final treatment on the initial activated carbon or the intermediate activated carbon. In embodiments where the optional intermediate treatment is omitted, the final treatment is performed on the initial activated carbon. In embodiments where the optional intermediate treatment is included, the final treatment is performed on the intermediate activated carbon. In some embodiments, the final treatment includes impregnation with a nitrogen-containing compound, and one of calcination, oxidation, or both calcination and oxidation, performed in any order. For example, in some embodiments, the final treatment includes impregnation with a nitrogen-containing compound and calcination. In some embodiments, the final treatment includes impregnation with a nitrogen-containing compound and oxidation. In some embodiments, the final treatment includes impregnation with a nitrogen-containing compound, calcination, and oxidation, wherein the calcination and oxidation are performed in any order. The final treatment yields the sorbent material.

In some embodiments, there is provided a method for making a sorbent material which includes about 5 wt. % to about 10 wt. % nitrogen and has an iodine number of about 1000 mg/g to about 1500 mg/g, the method including:
a. providing an activated carbon,
b. performing an initial treatment on the activated carbon, the initial treatment comprising:
   i. impregnation with a nitrogen-containing compound, and
   ii. one of calcination, oxidation, or both calcination and oxidation (in any order) to yield an initial activated carbon,
c. performing an optional intermediate treatment on the initial activated carbon which is performed 0-3 times, wherein each intermediate treatment independently comprises:
   i. impregnation with the nitrogen-containing compound, and
   ii. one of calcination, oxidation, or both calcination and oxidation (in any order) to yield an intermediate activated carbon,
d. performing a final treatment on the initial activated carbon or the intermediate activated carbon, the final treatment comprising:
   i. impregnation with the nitrogen-containing compound, and
   ii. one of calcination, oxidation, or both calcination and oxidation (in any order) to yield the sorbent material.

In some embodiments, step c. ii. is selected identically with step b. ii. In some embodiments, step c. ii. is selected differently from step b. ii. In some embodiments, step d. ii. is selected identically with step b. ii. In some embodiments, step d. ii. is selected differently from step b. ii. In some embodiments, steps c. ii. and d. ii. are both selected identically with step b. ii. In some embodiments, steps c. ii. and d. ii are both selected differently from step b. ii.

### Examples

TABLE 1 describes the properties, including nitrogen content and iodine number, of several commercial activated carbons. While the iodine number for Examples 1-5 approaches or exceeds 1000 mg/g, the nitrogen content does not exceed 2 wt. % in any of these materials.

TABLE 1
Commercial Activated Carbon Properties

| | | | Perox- | Wt. % | | Iodine | Apparent |
|---|---|---|---|---|---|---|---|
| | Carbon | | ide | Nitro- | | Number | Density |
| Ex. | Feedstock | CDR | Number | gen | % Ash | (mg/g) | (g/cc) |
| 1 | Catalytical | 39.1 | 2.0 | 1.63 | 10.2 | 907 | 0.506 |
| | coal | | | | | | |
| 2 | Catalytical | 18.6 | 5.8 | 1.13 | 4.2 | 1086 | 0.477 |
| | coal | | | | | | |
| 3 | Catalytical | 5.6 | 17.4 | 1.07 | 6.4 | 983 | 0.520 |
| | coal | | | | | | |
| 4 | Coconut | — | — | 0.70 | 0.67 | 1078 | 0.540 |
| 5 | Catalytic | 50.4 | 3.0 | 1.70 | 1.30 | 976 | 0.500 |
| | coconut | | | | | | |

TABLE 2 shows the properties of carbons prepared by variations methods, according to some embodiments of the present disclosure. Examples 7-11 represent attempts to achieve a bulk nitrogen level above 2.5 wt. % while maintaining an iodine number above 1000 mg/g. The processing methods used to prepare these Examples are described below. As shown in TABLE 2, a nitrogen content over 3 wt. % was achieved in Examples 7-10 with Examples 8-10 also exhibiting an iodine number of greater than 1300 mg/g. OLC-AW is an acid-washed coconut-based carbon feedstock. The GC-CTC-xx carbons are nitric acid-washed coconut carbons with a low ash content and a higher activity than OLC-AW, where “CTC-xx” refers to the carbon tetrachloride number.

TABLE 2
Oxygen Content of the Activated Carbons

| | | | | | | | | BET | |
|---|---|---|---|---|---|---|---|---|---|
| | | | | | | | Iodine | Surface | Apparent |
| | Carbon | Processing | | Peroxide | Wt. % | % | Number | Area | Density |
| Ex. | Feedstock | Method | CDR | Number | Nitrogen | Ash | (mg/g) | (m²/g) | (g/cc) |
| 7 | OLC- | A | 6.5 | 90.5 | 3.43 | 0.7 | 991 | 1185.0 | 0.503 |
| | AW | | | | | | | | |
| 8 | GC- | A | 5.0 | 151 | 3.20 | 1.2 | 1363 | 1622.7 | 0.396 |
| | CTC-90 | | | | | | | | |
| 9 | GC- | A | 4.6 | 57.3 | 3.22 | 1.6 | 1347 | 1473.8 | 0.416 |
| | CTC-85 | | | | | | | | |
| 10 | GC- | B | 5.4 | 138 | 3.07 | 1.3 | 1332 | 1573.3 | 0.413 |
| | CTC-90 | | | | | | | | |
| 11 | GC- | C | 5.5 | 60 | 2.62 | 1.1 | 1423 | 1656.9 | 0.371 |
| | CTC-90 | | | | | | | | |

### Processing Method A

The virgin activated carbon was sized to a mean particle diameter of about 1.4 mm and dried at about 105° C. The following steps were used to produce Examples 7-9.
a. The dried activated carbon was impregnated with an aqueous solution of 20 wt. % dicyandiamide (DCD) heated to 65° C. The amount of water used in the process is equivalent to a loading of ˜40 wt. % on a dry carbon basis. After this initial impregnation the carbon was dried for 2 hours at 150° C. After the drying step, the carbon was calcined under a flow of nitrogen at 950° C. for 1 hour. The sample was then cooled under a flow of nitrogen to ambient temperature.
b. This material was then oxidized under a flow of air for 1 hour at 1 liter per minute (LPM) at 430° C. The oxidized material was then allowed to cool in the same flow of air until ambient temperature was reached.
c. The oxidized material was then subjected again to the conditions of step a.

### Processing Method B

The virgin activated carbon was sized to a mean particle diameter of about 1.4 mm and dried at about 105° C. The following steps were used to produce Example 10.
a. The dried activated carbon was mixed with melamine in a dry admix process, such that the weight-based ratio of carbon to melamine was about 3.125:1.
b. The mixture of activated carbon and melamine was calcined under a flow of nitrogen at 950° C. for 1 hour. The sample was then cooled under a flow of nitrogen to ambient temperature.

### Processing Method C

The virgin activated carbon was sized to a mean particle diameter of about 1.4 mm and dried at about 105° C. The following steps were used to produce Example 11.
a. The dried activated carbon was impregnated with an aqueous solution of 40 wt. % urea. No heating of the solution was employed. After this initial impregnation the carbon was dried for 3 hours at 105° C. After the drying step, the carbon was calcined under a flow of nitrogen at 950° C. for 1 hour. The sample was then cooled under a flow of nitrogen to ambient temperature.
b. This material was then oxidized under a flow of air for 1 hour at 1 liter per minute (LPM) at 430° C. The oxidized material was then allowed to cool in the same flow of air until ambient temperature was reached.
c. The oxidized material was then subjected again to the conditions of step a.

Building upon the data obtained in TABLE 2, further experiments were conducted with the goal of reaching bulk nitrogen levels of 4-5 wt. % or higher while reducing the number of elevated thermal processing steps (such as calcination or oxidation). TABLE 3 below describes efforts to control the nitrogen content by varying calcination and oxidation temperatures.

TABLE 3

| | | | | | | | | BET | |
|---|---|---|---|---|---|---|---|---|---|
| | | | | | | | Iodine | Surface | Apparent |
| | Carbon | Processing | | Peroxide | Wt. % | % | Number | Area | Density |
| Ex. | Feedstock | Method | CDR | Number | Nitrogen | Ash | (mg/g) | (m²/g) | (g/cc) |
| 12 | OLC-AW | D | — | — | 4.62 | 1.1 | 911 | 789.5 | 0.565 |
| 13 | OLC-AW | E | — | — | 4.94 | 1.5 | 937 | 816.4 | 0.558 |
| 14 | OLC-AW | F | — | — | 4.40 | 1.0 | 876 | 776.7 | 0.579 |
| 15 | OLC-AW | G | — | — | 5.25 | 0.8 | 872 | 795.6 | 0.566 |
| 16 | OLC-AW | H | — | — | 4.96 | 1.4 | 1070 | 979.7 | 0.498 |

### Processing Method D

The virgin activated carbon was sized to a mean particle diameter of about 1.4 mm and dried at about 105° C. The following steps were used to produce Example 12.
a. The dried activated carbon was impregnated with an aqueous solution of 20 wt. % dicyandiamide (DCD) heated to 65° C. The amount of water used in the process is equivalent to a loading of ˜40 wt. % on a dry carbon basis. After this initial impregnation the carbon was dried for 2 hours at 150° C. After the drying step, the carbon was calcined under a flow of nitrogen at 850° C. for 1 hour. The sample was then cooled under a flow of nitrogen to ambient temperature.
b. This material was impregnated and dried once again according to the conditions of step a. The material was then oxidized under a flow of air for 1 hour at 1 liter per minute (LPM) at 400° C. The oxidized material was then allowed to cool in the same flow of air until ambient temperature was reached.
c. The oxidized material was then subjected again to the conditions of step a.

### Processing Method E

The virgin activated carbon was sized to a mean particle diameter of about 1.4 mm and dried at about 105° C. The following steps were used to produce Example 13.
a. The dried activated carbon was impregnated with an aqueous solution of 20 wt. % dicyandiamide (DCD) heated to 65° C. The amount of water used in the process is equivalent to a loading of ˜40 wt. % on a dry carbon basis. After this initial impregnation the carbon was dried for 2 hours at 150° C. After the drying step, the carbon was oxidized under a flow of air for 1 hour at 0.5 liter per minute (LPM) at 400° C.
b. The oxidized carbon was then impregnated and dried a second time following the procedure described in step a. Following the second impregnation and drying, the carbon was calcined at 850° C. for 1 hour and then allowed to cool under a flow of nitrogen.

### Processing Method F

The virgin activated carbon was sized to a mean particle diameter of about 1.4 mm and dried at about 105° C. The following steps were used to produce Example 14.
a. The dried activated carbon was impregnated with an aqueous solution of 20 wt. % dicyandiamide (DCD) heated to 65° C. The amount of water used in the process is equivalent to a loading of ˜40 wt. % on a dry carbon basis. After this initial impregnation, the carbon was dried in air for 2 hours at 150° C. After the drying step, the carbon was calcined at 850° C. in nitrogen for 1 hour then allowed to cool in nitrogen until ambient temperature was reached.
b. The carbon was then impregnated, dried, and calcined a second time following the procedure described in step a.

### Processing Method G

The virgin activated carbon was sized to a mean particle diameter of about 1.4 mm and dried at about 105° C. The following steps were used to produce Example 15.
a. The dried activated carbon was impregnated with an aqueous solution of 20 wt. % dicyandiamide (DCD) heated to 65° C. The amount of water used in the process is equivalent to a loading of ˜40 wt. % on a dry carbon basis. After this initial impregnation, the carbon was dried in air for 2 hours at 150° C. After the drying step, the carbon was calcined at 750° C. in nitrogen for 1 hour then allowed to cool in nitrogen until ambient temperature was reached.
b. The carbon was then impregnated, dried, and calcined a second time following the procedure described in step a.

### Processing Method H

The virgin activated carbon was sized to a mean particle diameter of about 1.4 mm and dried overnight at about 105° C. The following steps were used to produce Example 16.
a. The activated carbon was oxidized in air at 450° C. for 1 hour at an air flow rate of 0.5 liter per minute (LPM). The carbon was then allowed to cool to ambient temperature.
b. The oxidized carbon was impregnated with an aqueous solution of 20 wt. % dicyandiamide (DCD) heated to 65° C. The amount of water used in the process is equivalent to a loading of ˜40 wt. % on a dry carbon basis. After this initial impregnation, the carbon was dried in air for 2 hours at 150° C. After the drying step, the carbon was calcined at 850° C. in nitrogen for 1 hour then allowed to cool in nitrogen until ambient temperature was reached.

The conditions described herein were further investigated using coal-based activated carbons, as shown in TABLE 4. F400 and F400-HNO₃ are coal-based carbon feedstocks, wherein the latter is acid-washed.

TABLE 4

| | | | | | | | | BET | |
|---|---|---|---|---|---|---|---|---|---|
| | | | | | | | Iodine | Surface | Apparent |
| | Carbon | Processing | | Peroxide | Wt. % | % | Number | Area | Density |
| Ex. | Feedstock | Method | CDR | Number | Nitrogen | Ash | (mg/g) | (m²/g) | (g/cc) |
| 17 | F400 | I | — | — | 2.80 | — | — | — | 0.491 |
| 18 | F400- | J | — | — | 3.06 | — | — | — | 0/509 |
| | HNO₃ | | | | | | | | |

### Processing Method I

The virgin activated carbon was dried, and then the following steps were used to produce Example 17.
a. The dried activated carbon was oxidized in air at 430° C. for approximately 1 hour at a flow rate of 1.0 liters per minute. The carbon was then allowed to cool to ambient temperature, with a dry yield after oxidation of about 90-95%.
b. The oxidized carbon was impregnated with an aqueous solution of 20 wt. % dicyandiamide (DCD) heated to 65° C. The amount of water used in the process is equivalent to a loading of ˜40 wt. % on a dry carbon basis. The impregnated carbon was then dried in air for 2 hours at 150° C. After drying, the carbon was calcined at 950° C. in nitrogen for 1 hour and then allowed to cool in nitrogen until ambient temperature was reached.

### Processing Method J

The virgin activated carbon was dried, acid washed using 0.2 N nitric acid, and then subsequently rinsed with deionized water. The carbon was then dried overnight at 105° C., and then the following steps were used to produce Example 18.
a. The dried activated carbon was oxidized in air at 430° C. for approximately 1 hour at a flow rate of 1.0 liters per minute. The carbon was then allowed to cool to ambient temperature, with a dry yield after oxidation of about 90-95%.
b. The oxidized carbon was impregnated with an aqueous solution of 20 wt. % dicyandiamide (DCD) heated to 65° C. The amount of water used in the process is equivalent to a loading of ˜40 wt. % on a dry carbon basis. The impregnated carbon was then dried in air for 2 hours at 150° C. After drying, the carbon was calcined at 950° C. in nitrogen for 1 hour and then allowed to cool in nitrogen until ambient temperature was reached.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 compounds refers to groups having 1, 2, or 3 compounds. Similarly, a group having 1-5 cells refers to groups having 1, 2, 3, 4, or 5 compounds, and so forth.

Various of the above-disclosed and other features and functions, or alternatives thereof, may be combined into many other different systems or applications. Various presently unforeseen or unanticipated alternatives, modifications, variations, or improvements therein may be subsequently made by those skilled in the art, each of which is also intended to be encompassed by the disclosed embodiments.

What is claimed is:

1. A sorbent material, comprising:
activated carbon,
wherein the activated carbon has been subjected to an impregnation with a nitrogen-containing compound, and one of a calcination, an oxidation, or a calcination and an oxidation, and
wherein the sorbent material comprises about 5 wt. % to about 10 wt. % nitrogen and has an iodine number of about 1000 mg/g to about 1500 mg/g.

2. The sorbent material of claim 1, wherein the activated carbon comprises a carbonaceous material which is formed from bituminous coal, sub-bituminous coal, lignite coal, anthracite coal, wood, wood chips, sawdust, peat, nut shells, pits, coconut shell, babassu nut, macadamia nut, dende nut, peach pit, cherry pit, olive pit, walnut shell, wood, lignin, polymers, nitrogen-containing polymers, resins, petroleum pitches, bagasse, rice hulls, corn husks, wheat hulls and chaff, graphenes, carbon nanotubes, and polymer fibers.

3. The sorbent material of claim 2, wherein the carbonaceous material comprises coconut shell.

4. The sorbent material of claim 1, wherein the impregnation comprises contacting the activated carbon with an aqueous solution of about 10 wt. % to about 50 wt. % of the nitrogen-containing compound at a temperature of about 25° C. to about 75° C., combining the activated carbon and the nitrogen-containing compound in a dry admixture, or combinations thereof.

5. The sorbent material of claim 1, wherein the nitrogen-containing compound comprises ammonia, ammonium salts, ammonium carbonate and bicarbonate, ammonium thiocyanate, azodicarbonamide, diammonium phosphate, dicyandiamide, guanidine hydrochloride, guanidine thiocyanate, guanine, melamine, thiourea, urea, and combinations thereof.

6. The sorbent material of claim 1, wherein the calcination is performed at a temperature of about 350° C. to about 1000° C.

7. The sorbent material of claim 1, wherein the oxidation is performed at a temperature of about 300° C. to about 500° C.

8. The sorbent material of claim 1, wherein the sorbent material comprises about 6 wt. % to about 8 wt. % nitrogen.

9. The sorbent material of claim 1, wherein the sorbent material has an iodine number of about 1100 mg/g to about 1400 mg/g.

10. The sorbent material of claim 1, wherein the sorbent material comprises about 6 wt. % to about 8 wt. % nitrogen and has an iodine number of about 1100 mg/g to about 1400 mg/g.

11. The sorbent material of claim 1, wherein the sorbent material comprises less than about 2% ash.

12. A method for making a sorbent material which comprises about 5 wt. % to about 10 wt. % nitrogen and has an iodine number of about 1000 mg/g to about 1500 mg/g, the method comprising:
a. providing an activated carbon,
b. performing an initial treatment on the activated carbon, the initial treatment comprising:
i. impregnation with a nitrogen-containing compound, and
ii. one of calcination, oxidation, or both calcination and oxidation (in any order) to yield an initial activated carbon,
c. performing an optional intermediate treatment on the initial activated carbon which is performed 0-3 times, wherein each intermediate treatment independently comprises:
i. impregnation with the nitrogen-containing compound, and
ii. one of calcination, oxidation, or both calcination and oxidation (in any order) to yield an intermediate activated carbon,
d. performing a final treatment on the initial activated carbon or the intermediate activated carbon, the final treatment comprising:
i. impregnation with the nitrogen-containing compound, and
ii. one of calcination, oxidation, or both calcination and oxidation (in any order) to yield the sorbent material.

13. The method of claim 12, wherein the activated carbon comprises carbonaceous material which is formed from one or more of bituminous coal, sub-bituminous coal, lignite coal, anthracite coal, wood, wood chips, sawdust, peat, nut shells, pits, coconut shell, babassu nut, macadamia nut, dende nut, peach pit, cherry pit, olive pit, walnut shell, wood, lignin, polymers, nitrogen-containing polymers, resins, petroleum pitches, bagasse, rice hulls, corn husks, wheat hulls and chaff, graphenes, carbon nanotubes, or polymer fibers.

14. The method of claim 13, wherein the carbonaceous material is coconut shell.

15. The method of claim 12, wherein impregnation of the initial treatment, optional intermediate treatment, and final treatment comprises contacting the activated carbon with an aqueous solution of about 10 wt. % to about 50 wt. % of the nitrogen-containing compound at a temperature of about 25° C. to about 75° C., combining the activated carbon and the nitrogen-containing compound in a dry admixture in a ratio of about 1:1 to about 5:1, or combinations thereof.

16. The method of claim 12, wherein the nitrogen-containing compound comprises ammonia, ammonium salts, ammonium carbonate and bicarbonate, ammonium thiocyanate, azodicarbonamide, diammonium phosphate, dicyandiamide, guanidine hydrochloride, guanidine thiocyanate, guanine, melamine, thiourea, urea, and combinations thereof.

17. The method of claim 12, wherein the calcination of the initial treatment, optional intermediate treatment, and final treatment is performed at about 350° C. to about 1000° C.

18. The method of claim 12, wherein the calcination of the initial treatment, optional intermediate treatment, and final treatment is performed at a temperature of about 350° C. to about 600° C.

19. The method of claim 12, wherein the calcination of the initial treatment, optional intermediate treatment, and final treatment is performed at a temperature of about 600° C. to about 1000° C.

20. The method of claim 12, wherein the oxidation of the initial treatment, optional intermediate treatment, and final treatment is performed at about 300° C. to about 500° C.

21. The method of claim 12, wherein step c. ii. is selected identically with step b. ii.

22. The method of claim 12, wherein step c. ii. is selected differently from step b. ii.

23. The method of claim 12, wherein step d. ii. is selected identically with step b. ii.

24. The method of claim 12, wherein step d. ii. is selected differently from step b. ii.

25. The method of claim 12, wherein steps c. ii. and d. ii. are both selected identically with step b. ii.

26. The method of claim 12, wherein steps c. ii. and d. ii are both selected differently from step b. ii.
